(19) United States
(12) Patent Application Publication
(10) Pub. No.: US 2021/0039236 A1
(43) Pub. Date: Feb. 11, 2021

(54) DRAINAGE PIPE CONNECTION TOOL

(71) Applicant: James Eric Czipulis, West Palm Beach, FL (US)

(72) Inventor: James Eric Czipulis, West Palm Beach, FL (US)

(21) Appl. No.: 16/989,390

(22) Filed: Aug. 10, 2020

Related U.S. Application Data
(60) Provisional application No. 62/884,929, filed on Aug. 9, 2019.

(51) Int. Cl. B25B 27/02

(52) U.S. Cl. CPC B25B 27/02; F16L 33/00

(57) ABSTRACT

A drainage pipe connection tool for connecting two adjacent sections of corrugated, high density polyethylene (HDPE) drainage pipe or a section of HDPE drainage pipe to a collecting basin includes a first brace member, a second brace member with a tensioning member pivotally fitted thereto and straps extending between the first brace member and the second brace member. In use, the first brace member is fitted to one of the corrugated sections of HDPE drainage pipe or behind a female bell-shaped opening of the basin, and the second brace member is fitted to the adjacent section of HDPE drainage pipe. The straps are pulled taut to remove slack, and a lever of the tensioning member is operated to apply tension on the straps, urging the adjacent drainage pipe sections together or the pipe section into the open female bell of the basin.

This non-provisional patent application is based on provisional patent application No. 62/884,929 filed on Aug. 9, 2019.

### BACKGROUND OF THE INVENTION

### Field of the Invention

The present invention is directed to a device for connecting adjacent sections of corrugated, high density polyethylene (HDPE) drainage pipe sections together or for connecting a section of HDPE drainage pipe to a collecting basin.

Drainage systems are used to direct rainwater and other water that collects on the soil or other surfaces to an appropriate collecting area, such as a sewer, connecting canal or reservoir. Most drainage systems installed today use high density polyethylene (HDPE) drainage pipe having a smooth interior surface and an exterior corrugated surface that has an arrangement of spaced ribs with troughs between each of the ribs. One end of the HDPE drainage pipe section has a female end and the opposite end is smaller in diameter, to define a male end. The pipe sections are connected together by pushing the male end into the female end using sufficient force. Currently, the instructed method of applying force to connect HDPE drainage pipe sections together, or to connect a section of HDPE drainage pipe to an open bell of a collecting basin, is to use a pry bar that is inserted into the ground and pushed against one end of the HDPE drainage pipe to urge the section of drainage pipe into the female end of the adjacent and aligned section of drainage pipe, or collecting basin. For larger diameter drainage pipe, the instructed method is to use heavy equipment, such as the bucket of a backhoe, urging the bucket against the end of the drainage pipe. The proper instructions call for placing a flat board against the end of the drainage pipe to receive the force of the pry bar or heavy equipment, to minimize damage to the end of the pipe. Nonetheless, these methods of applying force to sections of drainage pipe to connect drainage pipe sections together, or to connect a section of drainage pipe to a basin, often creates damage to the end of the drainage pipe. In order to assist with the connection of two adjacent sections of drainage pipe, or the connection of a section of drainage pipe to a collecting basin, it is often necessary to apply a fairly expensive lubricant to the male end to overcome friction. Use of this lubricant increases the cost of the drainage pipe installation job. Moreover, the prescribed methods of connecting drainage pipe sections together, as described above, require a considerable amount of labor and time.

Accordingly, there is a need for a tool for effectively connecting adjacent sections of drainage pipe, or for connecting a section of drainage pipe to a collecting basin, without damaging the drainage pipe, and with minimal effort and time involved to accomplish the task.

### SUMMARY OF THE INVENTION

The present invention is directed to a drainage pipe connection tool for connecting two adjacent sections of corrugated, high density polyethylene (HDPE) drainage pipe or a section of HDPE drainage pipe to a collecting basin. The connection tool includes a first brace member, a second brace member with a tensioning member pivotally fitted thereto and straps connected to and extending between the first brace member and the tensioning member on the second brace member. In use, the first brace member is fitted to one of the corrugated sections of HDPE drainage pipe or the basin, and the second brace member is fitted to the adjacent section of HDPE drainage pipe. The straps are connected between the first brace member and the tensioning member on the second brace member, so that the straps extend along opposite sides of the drainage pipe. When properly fitted, with the straps pulled taut to remove slack, a lever of the tensioning member is operated to apply tension on the straps, urging the adjacent drainage pipe sections together or the pipe section into the bell-shaped female opening of a connection port near the bottom of the collecting basin, to urge the pipe sections together.

### BRIEF DESCRIPTION OF THE DRAWINGS

For a fuller understanding of the nature of the present invention, reference should be made to the accompanying drawings in which:

FIG. 1 is a perspective view of a second brace member and pivotally attached tensioning member of the drainage pipe connection tool;

FIG. 2 is a perspective view of a first brace member of the drainage pipe connection tool;

FIG. 3 is a top perspective view showing the full assembly of the drainage pipe connection tool including the first brace member, the second brace member and pivotally attached tensioning member, and tension straps connected to and extending between the tensioning member and the first brace member;

FIG. 4 is a top perspective view showing the full assembly of the drainage pipe connection tool and demonstrating movement of a lever of the tensioning member to cause the tensioning member to pivot relative to the second brace member and apply further tension on the straps, thereby exerting a pulling force between the first brace member and the second brace member;

FIG. 5 is a top perspective view showing a male end of a section of the corrugated HDPE drainage pipe ready for insertion within a bell-shaped female opening on a collecting basin;

FIG. 6 is a top perspective view showing the male end of the drainage pipe section partially received within the bell-shaped female opening on the collecting basin;

FIG. 7 is a top perspective view illustrating the drainage pipe connection tool of the present invention in use and installed on the corrugated HDPE drainage pipe section with the first brace member fitted behind the enlarged bell-shaped female opening of the collecting basin;

FIG. 8 is a top perspective view similar to FIG. 7 and showing pivotal moving operation of the tensioning member of the drainage pipe connection tool to urge the corrugated HDPE drainage pipe section fully into the enlarged bell-shaped female opening, as indicated by the arrow;

FIG. 9 is a side elevational view, in partial cross-section, showing the drainage pipe connection tool of the present invention installed on the corrugated HDPE drainage pipe section with the first brace member fitted behind the enlarged bell-shaped female opening of the collecting basin;

FIG. 10 is a side elevational view, in partial cross-section, similar to FIG. 9 and demonstrating movement of the tensioning member to urge the male end of the corrugated HDPE drainage pipe section fully within the bell-shaped female opening on the collecting basin;

FIG. 11 is a perspective view illustrating an alternative embodiment of the first brace member, wherein the first brace member includes two semi-circular members that are pivotally attached to one another and wherein the semi-circular members are shown in an open position to allow for placement of the brace member over either the collecting basin connection port, just behind the bell-shaped female opening or, alternatively, to the corrugated rib and trough structure of a section of HDPE pipe; and

FIG. 12 is a perspective view showing the alternative embodiment of the first brace member of FIG. 11 in the closed position so that the inner edges of the two semi-circular members form a complete, closed circle to fully encompass the drainage pipe section or the connection port on the collecting basin, just behind the enlarged bell-shaped female opening, as seen in FIGS. 9 and 10.

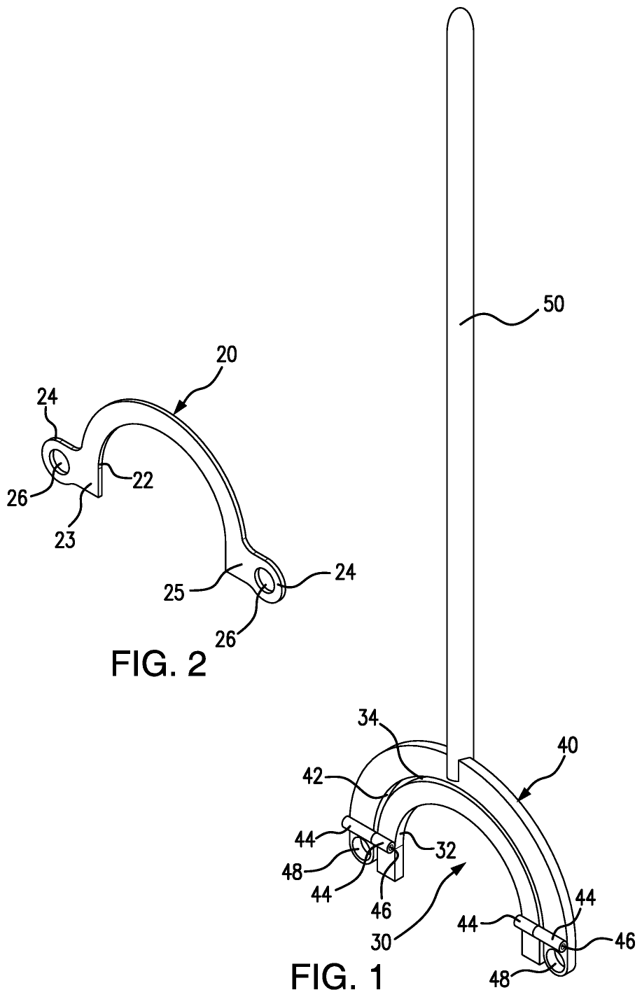

Like reference numerals refer to like parts throughout the several views of the drawings.

### DETAILED DESCRIPTION OF THE PREFERRED EMBODIMENTS

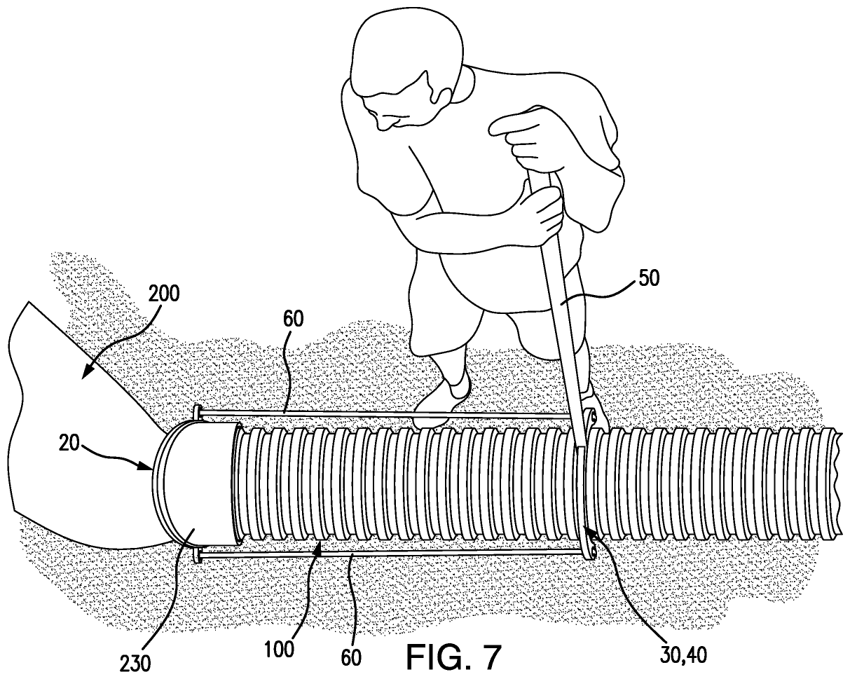

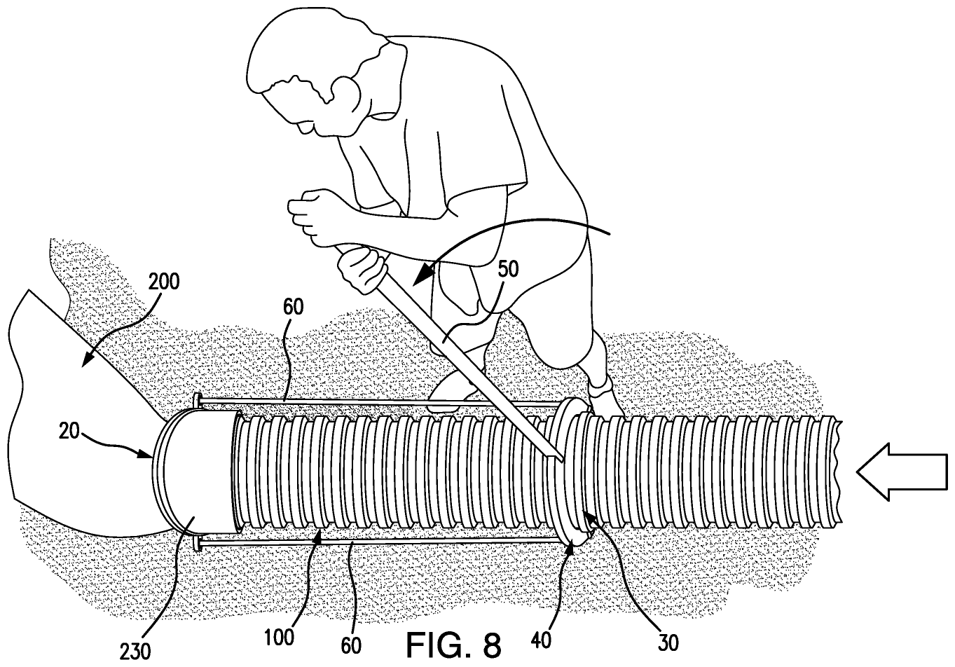

Referring to the several views of the drawings, the drainage pipe connection tool is shown and is generally indicated as 10. The drainage pipe connection tool 10 is specifically structured for connecting adjacent sections of corrugated, high density polyethylene (HDPE) drainage pipe 100 together or for connecting a section of HDPE drainage pipe 100 to a female bell opening 230 of a collecting basin 200. The connecting tool 10 includes a first brace member 20 that is arch-shaped with an inner edge 22 formed about a radius that is approximately equal to the outer radius of the HDPE drainage pipe 100 within the trough 110 between two adjacent ribs 120 of the exterior corrugated structure of the HDPE drainage pipe 100. The first brace member 20 further includes ear members 24 extending outwardly at opposite ends 23, 25 of the arch-shaped configuration of the first brace member. Each of the ear members includes a hole 26 formed therethrough, as seen in the drawings. The inner edge 22, being formed about a radius that is generally equal to the outer radius of the trough of the HDPE drainage pipe 100, continues in a generally straight line near the bottom end portions 23, 25 of the arch-shaped structure, adjacent to the ear members 24. This allows the first brace member 20 to be securely seated within the trough 110 of the drainage pipe with the ear members 24 being slightly below the center of the drainage pipe 100, while also allowing for ease of placement and removal of the first brace member 20 from the drainage pipe 100. Alternatively, as shown in FIGS. 7-8, the first brace member 20 can be fitted over the connection port 210 of a collecting basin 200, on a tubular extension 220 just behind an enlarged bell-shaped female opening 230. The outer diameter of the tubular extension 220 is equal to, or nearly equal to the outer diameter of the troughs 110 on the drainage pipe 100.

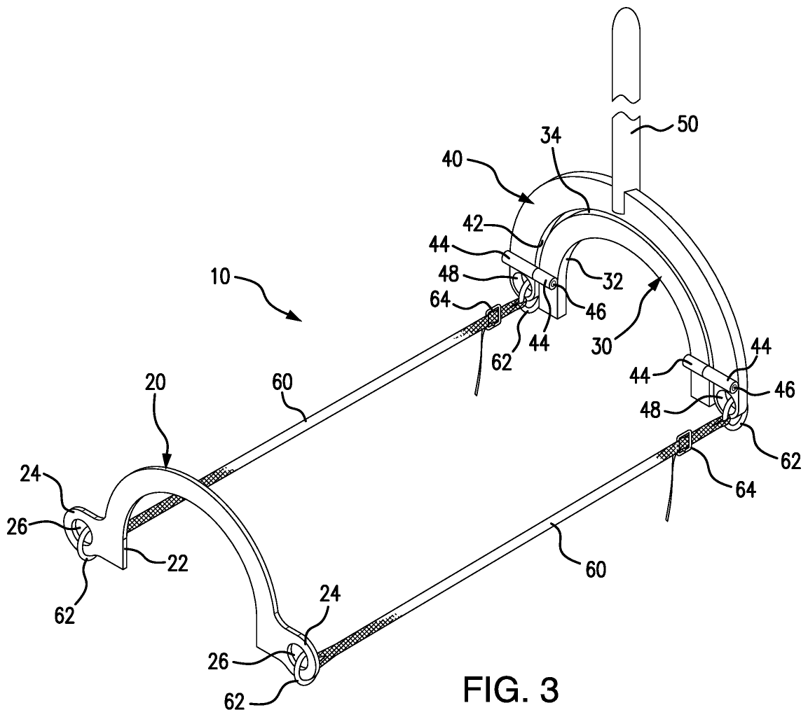

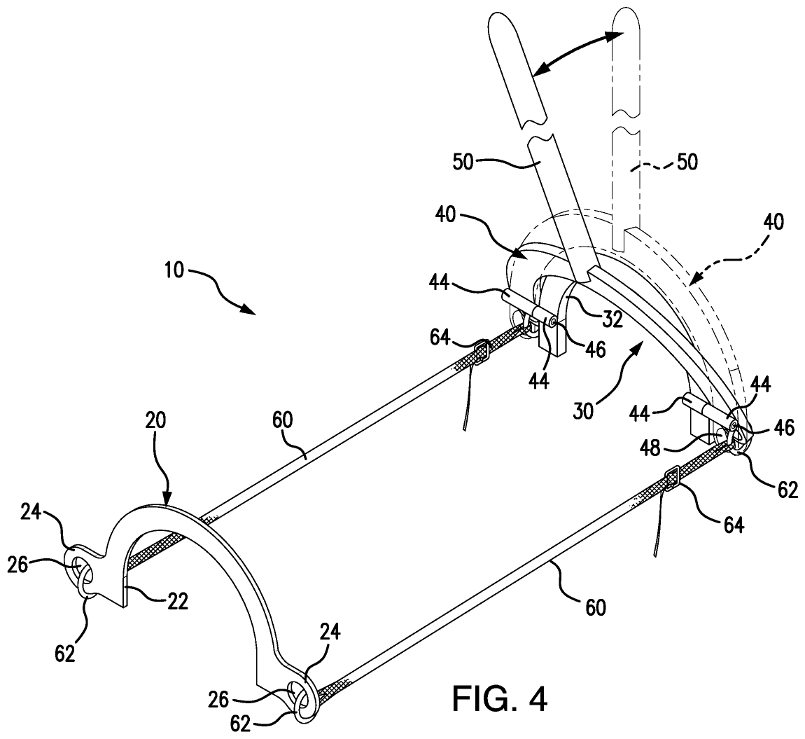

The drainage pipe connection tool 10 further includes a second brace member 30 that is also arch-shaped and includes an inner edge 32 formed about a radius that is generally equal to the outer surface radius of the trough 110 of the exterior corrugated structure of the drainage pipe 100, and also being generally equal to the radius of the inner edge 22 of the first brace member 20. Similar to the first brace member 20, the second brace member 30 is adapted to be received within a trough 110 between adjacent ribs 120 of the exterior corrugated structure of the drainage pipe 100. The second brace member 30 further includes a tensioning member 40 that is pivotally connected on opposite sides to the arch-shaped structure of the second brace member 30. The tensioning member 40 also includes an arch-shaped structure that is generally congruent to the arch-shaped structure of the second brace member 30 so that an inner edge 42 of the arch structure of the tensioning member 40 follows the radius of an outer edge 34 of the second brace member 30 in spaced relation thereto, as best seen in FIGS. 2 and 3. Sleeves 44 on both the second brace member and the arch structure of the tensioning member align to allow passage of axle pins 46 therethrough on opposite sides of the second brace member 30 and tensioning member 40 to provide the pivotal connection of the tensioning member 40 to the second brace member 30. Opposite lower ends of the arch structure of the tensioning member include holes 48 formed therethrough. An elongate bar 50 is fixed to a top of the arch-shaped structure of the tensioning member 40 and extends therefrom, as seen in the drawings. The elongate bar 50 serves as a lever to pivotally move the tensioning member 40 relative to the second brace member 30 in a manner that moves the lower ends and holes 48 of the tensioning member 40 away from the ear members 24 on the first brace member 20, thereby exerting a force under tension to tension straps 60, as described more fully hereinafter.

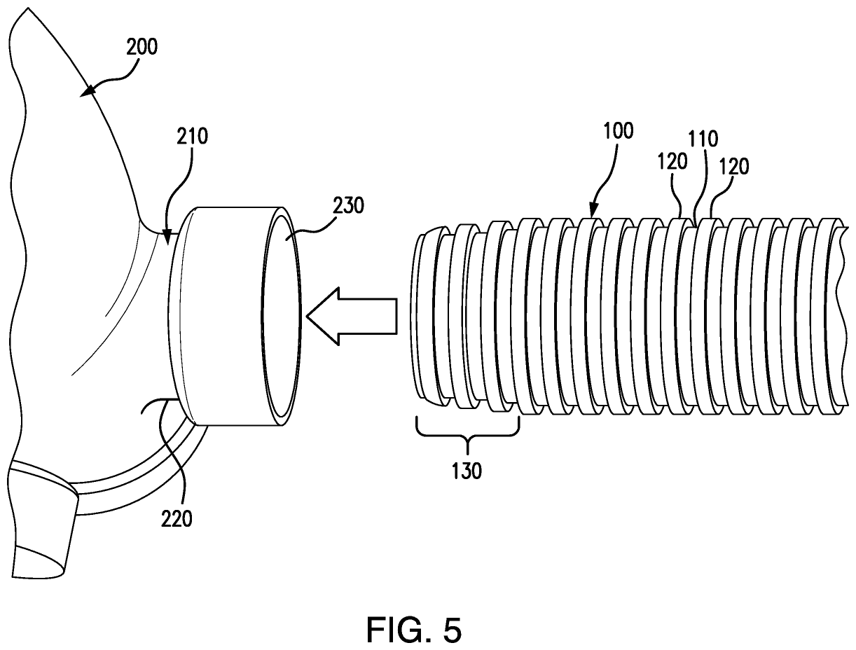

As seen in FIGS. 3-4, the first brace member 20 is interconnected to the tensioning member 40 by straps 60 that connect to the holes 26 on the first brace member and holes 48 on the tensioning member 40. It should be noted that the use of the ear members 24 and holes 26 and 48 on the first brace member 20 and tensioning member 40 are a matter of design choice and that it is fully contemplated that these structures may be modified or replaced with an alternative means of connecting the straps 60 between the first brace member 20 and the tensioning member 40. The straps are preferably made of a durable material that stretches very minimally under tension, such as a woven nylon material. The straps 60 are intended to be maintained taut at all times, once the drainage pipe connection tool 10 is installed on the drainage pipe sections 100 or between a drainage pipe section 100 and a collecting basin 200. Because the distance between the first brace member 20 and the second brace member 30 and tensioning member 40 will vary during use of the connection tool 10 with different type installations, it is necessary to be able to adjust the overall length of the straps 60 so that they are maintained taut once the drainage pipe connection tool 10 is fitted on the pipe sections for use. In at least one embodiment, the straps 60 are provided with buckles 64 that allow the straps to be tightened once the drainage pipe connection tool 10 is seated and fitted to the adjacent pipe sections 100 or a pipe section 100 and the collecting basin 200. Then, upon operation of the lever bar 50, in a pivoting action to move the lower ends of the tensioning member 40 and holes 48 away from the lower ends of the first brace member 20, the straps 60 are pulled even tighter under tension, creating a pulling force between the tensioning member 40 and the first brace member 20.

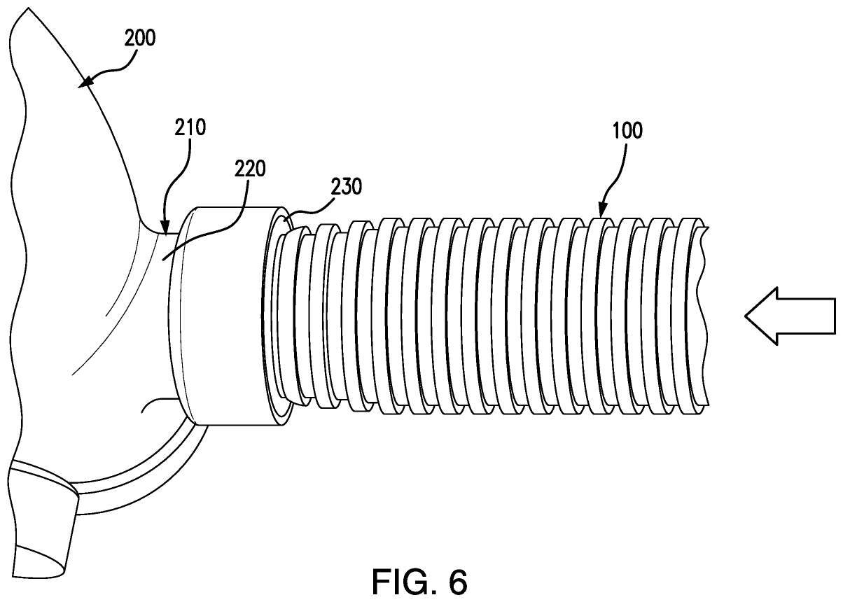

Referring to FIGS. 5-8, installation of a drainage pipe section 100 to the enlarged bell-shaped female opening 230 of a connection port 210 of a collecting basin 200 is illustrated. As seen in FIGS. 5 and 6, the male end 130 of the drainage pipe section 100 is directed into the enlarged bell-shaped female opening 230 until it is seated in frictional engagement within the bell-shaped female opening 230. Thereafter, the drainage pipe connection tool 10 is fitted to the drainage pipe section 100 and a connection port extension 220 of the collecting basin 200, as seen in FIGS. 7 and 8. Specifically, the first brace member 20 is fitted over the connection port extension 220, just behind the enlarged bell-shaped female opening 230 and the second brace member 30 is placed within a selected trough 110 on the exterior corrugated structure of the drainage pipe section 100. The selected trough 110 along the length of the drainage pipe section 100 should be such that the straps 60 are pulled taut but in a manner that maintains the second brace member 30 and tensioning member 40 in general vertical alignment with one another with the lever bar 50 essentially straight up and perpendicular to the drainage pipe section 100, as seen in FIG. 7. If necessary, the straps 60 can be tightened so that they are taut, as seen in FIG. 7. The lever bar 50 can then be moved, as indicated by the directional arrow in FIG. 8, to cause a pivoting movement of the tensioning member 40 relative to the second brace member 30, thereby increasing tension on the straps 60 and creating a pulling force between the connection port 210 and the drainage pipe section 100 in a manner that urges the drainage pipe section 100 fully into the enlarged bell-shaped female opening 230, as indicated in FIG. 8.

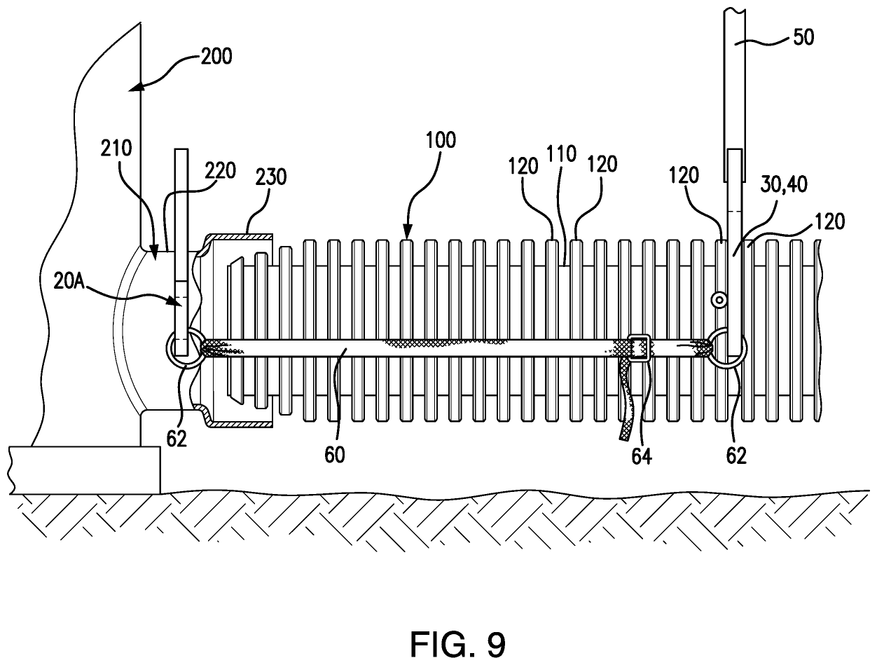

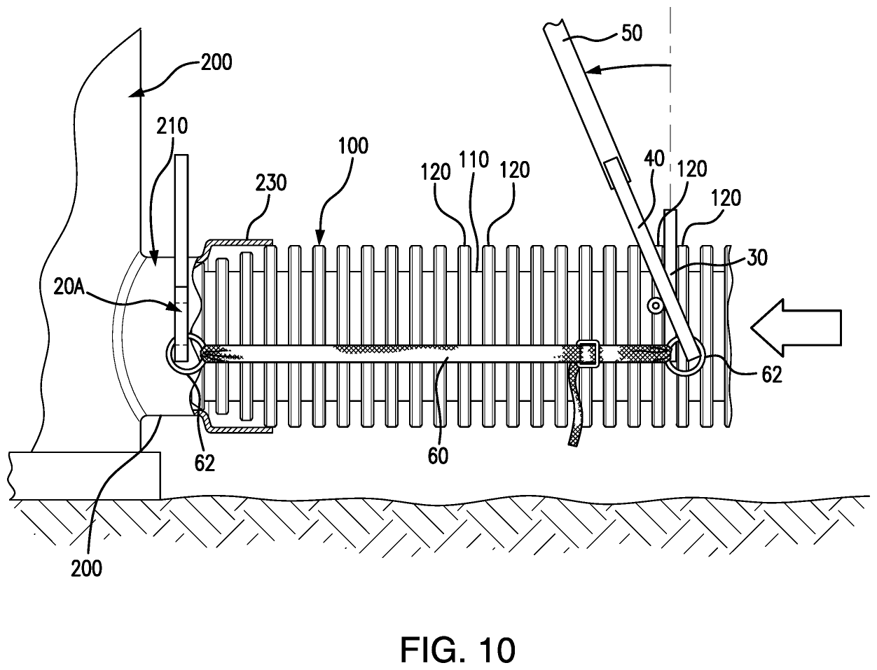

FIGS. 9 and 10 illustrate the connection operation of the drainage pipe connection tool 10 in a side elevational view, shown in partial cross-section, wherein the male end of the drainage pipe section 100 is shown within the enlarged bell-shaped female opening 230 and, upon pivoting movement of the lever bar 50 and tensioning member 40, from the vertical position seen in FIG. 9, and in the direction of the arrow shown in FIG. 10, tension is applied to the straps 60 to urge the male end of the drainage pipe section 100 fully into the enlarged bell-shaped female opening 230 so that the male end of the drainage pipe section 100 is fully seated and sealed within the connection port 210 of the collecting basin 200. It should be noted that this same operation is achieved when connecting two adjacent sections of drainage pipe sections 100, wherein a male end of one drainage pipe section 100 is received within a larger diameter female end of an adjacent drainage pipe section 100, with the first brace member 20 seated within a trough on the corrugated structure of one drainage pipe section and the second brace member 30 seated within a selected trough on the exterior corrugated structure of the adjacent drainage pipe section, and whereupon operation of the lever bar 50, in the same action as indicated in FIG. 10, will serve to urge the male end of the one drainage pipe section 100 fully within the female opening of the adjacently aligned drainage pipe section. This connection operation, as described above, is achieved without the need for lubricants and without damaging the ends of the drainage pipe sections 100.

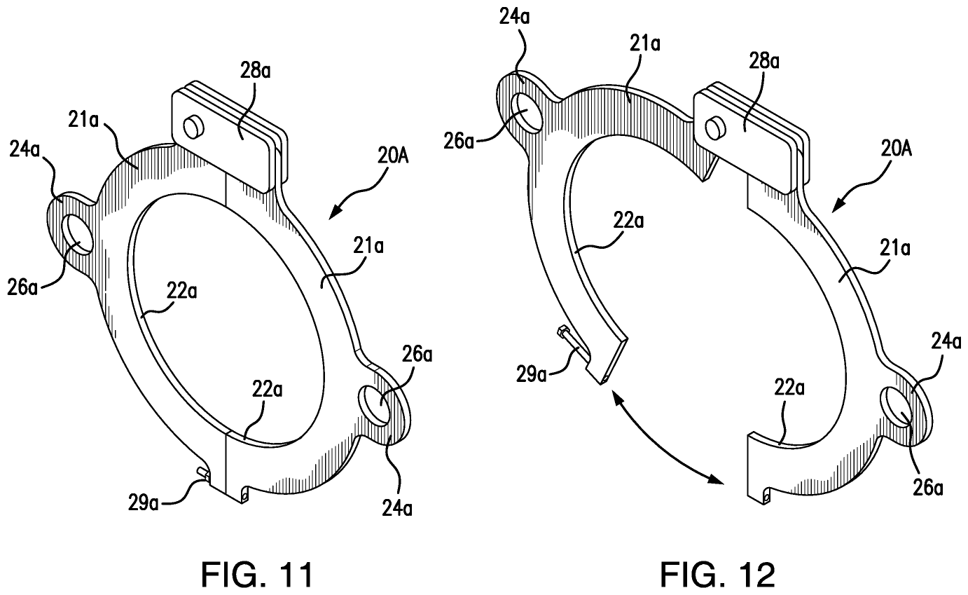

Referring to FIGS. 11 and 12, an alternative embodiment of the first brace member is shown and is generally indicated as 20A. In this embodiment, the first brace member 20A includes two semi-circular members 21a that are pivotally attached at 28a to allow movement of the semi-circular members 21a from a closed position, as shown in FIG. 11, to an open position, as shown in FIG. 12. The semi-circular members 21a include inner edges 22a that form a complete, closed circle to fully encompass the exterior structure of the drainage pipe section 100 or connection port extension 220 on the collecting basin 200, just behind the enlarged bell-shaped female opening 230, as shown in FIGS. 9 and 10. The pivoting movement of the semi-circular members 21a, as shown in FIG. 12, allows for placement and removal of the first brace member 20A on and off of the pipe section 100 or connection port extension 220 of the collecting basin 200. Once fitted into either the trough 110 of a drainage pipe section 100 or around the connection port extension 220 of a collecting basin 200, the semi-circular members 21a are closed and secured by a bolt 29a or similar fastening element. Each of the semi-circular members 21a includes an outwardly extending ear member 24a with a hole 26a formed through each ear member 24a to allow for attachment of the straps 60, as shown in FIGS. 9 and 10.

While the present invention has been shown and described in accordance with several preferred and practical embodiments, it is recognized that departures from the instant disclosure are fully contemplated within the spirit and scope of the present invention which is not to be limited except as defined in the following claims as interpreted under the Doctrine of Equivalents.

What is claimed is:

1. A drainage pipe connection tool for connecting two sections of drainage pipe having an exterior corrugated structure, or for connecting a section of the drainage pipe to a connecting port of a collecting basin, the drainage pipe connection tool comprising:
a first brace member structured to be fitted onto the exterior corrugated structure of one of the drainage pipe sections or to the connecting port of the collecting basin;
a second brace member structured to be fitted to the exterior corrugated structure of an adjacent one of the sections of drainage pipe;
a tensioning member pivotally fitted to the second brace member and including an elongate lever bar for moving the tensioning member in a pivoting action relative to the second brace member and the first brace member so that a lower portion of the tensioning member moves away from the first brace member to define an operational movement of the tensioning member; and
at least two tension straps connecting between the lower portion of the tensioning member and the first brace member, whereupon operational movement of the tensioning member creates increased tension of the tension straps and a pulling force between the first brace member and the second brace member, thereby urging the two sections of corrugated drainage pipe together or the adjacent one of the sections of corrugated drainage pipe and the connecting port of the collecting basin together.

2. The drainage pipe connection tool as recited in claim 1 wherein the first brace member and the second brace member each include an inner edge that is sized and configured for congruent fit around at least a portion of the exterior corrugated structure of the two sections of drainage pipe.

3. The drainage pipe connection tool as recited in claim 1 wherein the first brace member includes an inner edge that is sized and configured for congruent fit about at least a portion of the connecting port of the collecting basin.

4. The drainage pipe connection tool as recited in claim 1 wherein the second brace member includes an inner edge that is sized and configured for congruent fit about at least a portion of the exterior corrugated structure of the adjacent one of the sections of drainage pipe.

5. The drainage pipe connection tool as recited in claim 1 wherein the first brace member includes ear members extending outwardly at opposite lower ends of the first brace member, and each of the ear members being structured for attachment of one of the tension straps thereto.

6. The drainage pipe connection tool as recited in claim 1 wherein the elongate lever bar is fixedly attached to a top of the tensioning member.

7. The drainage pipe connection tool as recited in claim 1 wherein the lower portion of the tensioning member includes opposite lower ends outboard of the second brace member, and each of the opposite lower ends being structured for attachment of one of the tension straps thereto.
